(19) United States
(12) Patent Application Publication
(10) Pub. No.: US 2014/0339990 A1
(43) Pub. Date: Nov. 20, 2014

(54) LIGHT-EMITTING DIODE LIGHTING DEVICE HAVING MULTIPLE DRIVING STAGES

(71) Applicant: IML International, Grand Cayman (KY)

(72) Inventors: Horng-Bin Hsu, Taipei City (TW); Yi-Mei Li, New Taipei City (TW); Yung-Hsin Chiang, New Taipei City (TW)

(73) Assignee: IML International, Grand Cayman (KY)

(21) Appl. No.: 13/972,854

(22) Filed: Aug. 21, 2013

Related U.S. Application Data
(60) Provisional application No. 61/823,409, filed on May 15, 2013.

(51) Int. Cl. H05B 33/08

(52) U.S. Cl. CPC H05B 33/089
USPC 315/161

(57) ABSTRACT

An LED lighting device includes multiple driving stages. A first driving stage includes a first luminescent device driven by a first current and a first current controller coupled in parallel with the first luminescent device. The first current controller is configured to conduct a second current according to a voltage established across the first current controller and regulate the second current so that a sum of the first current and the second current does not exceed a first value. The second driving stage includes a second luminescent device driven by a third current and a second current controller coupled in series to the second luminescent device. The second current controller is configured to conduct a fourth current according to a voltage established across the second current controller and regulate the fourth current so that a sum of the third current and the fourth current does not exceed a second value.

### CROSS REFERENCE TO RELATED APPLICATIONS

This application claims the benefit of U.S. provisional application No. 61/823,409 filed on May 15, 2013.

### BACKGROUND OF THE INVENTION

1. Field of the Invention

The present invention is related to an LED lighting device having multiple driving stages, and more particularly, to an LED lighting device having multiple driving stages for providing wide operational voltage range and high reliability.

2. Description of the Prior Art

Compared to traditional incandescent bulbs, light-emitting diodes (LEDs) are advantageous in low power consumption, long lifetime, small size, no warm-up time, fast reaction speed, and the ability to be manufactured as small or array devices. In addition to outdoor displays, traffic signs, and liquid crystal display (LCD) backlight for various electronic devices such as mobile phones, notebook computers or personal digital assistants (PDAs), LEDs are also widely used as indoor/outdoor lighting devices in place of fluorescent of incandescent lamps.

An LED lighting device directly driven by a rectified alternative-current (AC) voltage usually adopts a plurality of LEDs coupled in series in order to provide required luminance. As the number of the LEDs increases, a higher forward-bias voltage is required for turning on the LED lighting device, thereby reducing the effective operational voltage range of the LED lighting device. As the number of the LEDs decreases, the large driving current when the rectified voltage is at its maximum level may impact the reliability of the LEDs. Therefore, there is a need for an LED lighting device capable of improving the effective operational voltage range and the reliability.

### SUMMARY OF THE INVENTION

The present invention provides an LED lighting device having a first driving stage and a second driving stage. The first driving stage includes a first luminescent device for providing light according to a first current; and a first current controller coupled in parallel with the first luminescent device and configured to conduct a second current according to a voltage established across the first current controller and regulate the second current so that a sum of the first current and the second current does not exceed a first value. The second driving stage includes a second luminescent device coupled in series to the first luminescent device for providing light according to a third current; and a second current controller coupled in series to the second luminescent device and configured to regulate the third current so that the third current does not exceed a second current setting which is larger than the first value, wherein each of the first and second luminescent devices includes one LED or multiple LEDs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an LED lighting device according to an embodiment of the present invention.

FIGS. 2 and 3 are diagrams illustrating the operation of the current controllers in the multiple driving stages.

FIG. 4 is a diagram illustrating the operation of the LED lighting device.

FIG. 5 is a diagram illustrating an embodiment of a current controller according to the present invention.

FIG. 6 is a diagram of an LED lighting device according to another embodiment of the present invention.

### DETAILED DESCRIPTION

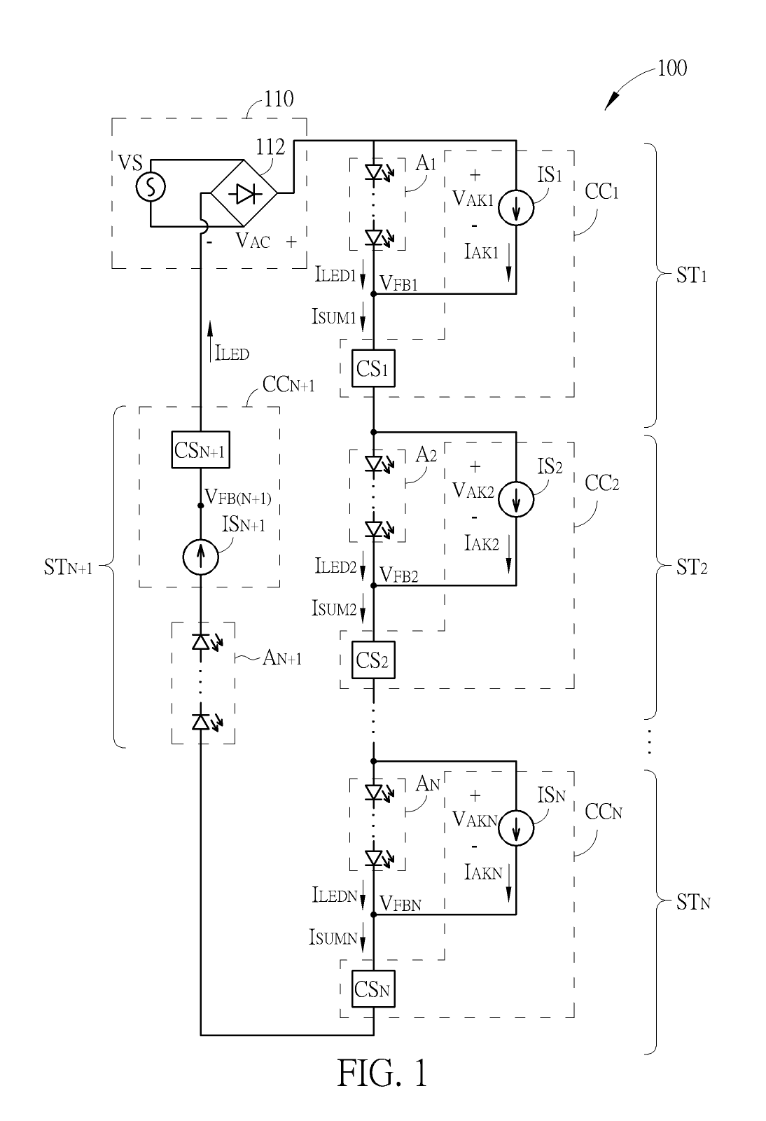

FIG. 1 is a diagram of an LED lighting device 100 according to an embodiment of the present invention. The LED lighting device 100 includes a power supply circuit 110 and (N+1) driving stages ST₁˜ST_{N+1} (N is a positive integer larger than 1). The power supply circuit 110 is configured to receive an AC voltage VS having positive and negative periods and convert the output of the AC voltage VS in the negative period using a bridge rectifier 112, thereby providing a rectified AC voltage V_{AC}, whose value varies periodically with time, for driving the (N+1) driving stages. In another embodiment, the power supply circuit 110 may receive any AC voltage VS, perform voltage conversion using an AC-AC converter, and rectify the converted AC voltage VS using the bridge rectifier 112, thereby providing the rectified AC voltage V_{AC} whose value varies periodically with time. The configuration of the power supply circuit 110 does not limit the scope of the present invention.

Each driving stage includes a luminescent device and a current controller. Each current controller includes an adjustable current source and a current sensor. A₁˜A_{N+1} represent the luminescent devices in the corresponding driving stages ST₁˜ST_{N+1}, respectively. CC₁˜CC_{N+1} represent the current controllers in the corresponding driving stages ST₁˜ST_{N+1}, respectively. IS₁˜IS_{N+1} represent the adjustable current sources in the corresponding current controllers CC₁˜CC_{N+1}, respectively. CS₁˜CS_{N+1} represent the current sensors in the corresponding current controllers CC₁˜CC_{N+1}, respectively. V_{AK1}˜V_{AK(N+1)} represent the voltages established across the adjustable current sources IS₁˜IS_{N+1}, respectively. I_{AK1}˜I_{AKN} represent the currents flowing through the adjustable current sources IS₁˜IS_{N}, respectively. I_{LED1}˜I_{LEDN} represent the currents flowing through the luminescent devices A₁˜A_{N}, respectively. I_{SUM1}˜I_{SUMN} represent the currents flowing through the corresponding driving stages ST₁˜ST_{N}, respectively. I_{LED} represents the current flowing through the driving stage ST_{N+1}, which is also the overall current flowing through the LED lighting device 100.

In the 1^{st} to N^{th} driving stages ST₁˜ST_{N}, the current sensors CS₁˜CS_{N} are configured to provide feedback voltages V_{FB1}˜V_{FBN} which are associated with the total currents I_{SUM1}˜I_{SUMN} flowing through the corresponding driving stages ST₁˜ST_{N}, respectively. The adjustable current sources IS₁˜IS_{N}, coupled in parallel with the corresponding luminescent devices A₁˜A_{N}, are configured to regulate the currents I_{AK1}˜I_{AKN} according to the corresponding feedback voltages V_{FB1}˜V_{FBN}, respectively. In other words, the maximum current settings I_{SET1}˜I_{SETN} of the 1^{st} to N^{th} driving stages ST₁˜ST_{N} are determined by the corresponding adjustable current sources IS₁˜IS_{N} and the corresponding current sensors CS₁˜CS_{N}, respectively.

In the (N+1)^{th} driving stage ST_{N+1}, the current sensor CS_{N+1}, coupled in series to the corresponding luminescent device A_{N+1} is configured to provide a feedback voltage V_{FB(N+1)} which is associated with the total current I_{LED} flowing through the (N+1)^{th} driving stage ST_{N+1}. The adjustable current source IS_{N+1}, coupled in series to the corresponding luminescent device A_{N+1} is configured to regulate the current I_{LED} according to the feedback voltage V_{FB(N+1)}. In other words, the maximum current setting I_{SET(N+1)} of the (N+1)^{th} driving stage, which is also the maximum current setting of the LED lighting device 100, is determined by the adjustable current source IS_{N+1} and the current sensor CS_{N+1}.

In the embodiment of the present invention, each of the luminescent devices A₁˜A_{N+1} may adopt a single LED or multiple LEDs coupled in series. FIG. 1 depicts the embodiment using multiple LEDs which may consist of single-junction LEDs, multi-junction high-voltage (HV) LEDs, or any combination of various types of LEDs. The types and configurations of the luminescent devices A₁˜A_{N+1} do not limit the scope of the present invention. In a specific driving stage, the dropout voltage V_{DROP} for turning on the corresponding current controller is smaller than the cut-in voltage V_{CUT} for turning on the corresponding luminescent device. The value of the cut-in voltage V_{CUT} is related to the number or type of the LEDs in the corresponding luminescent device and may vary in different applications.

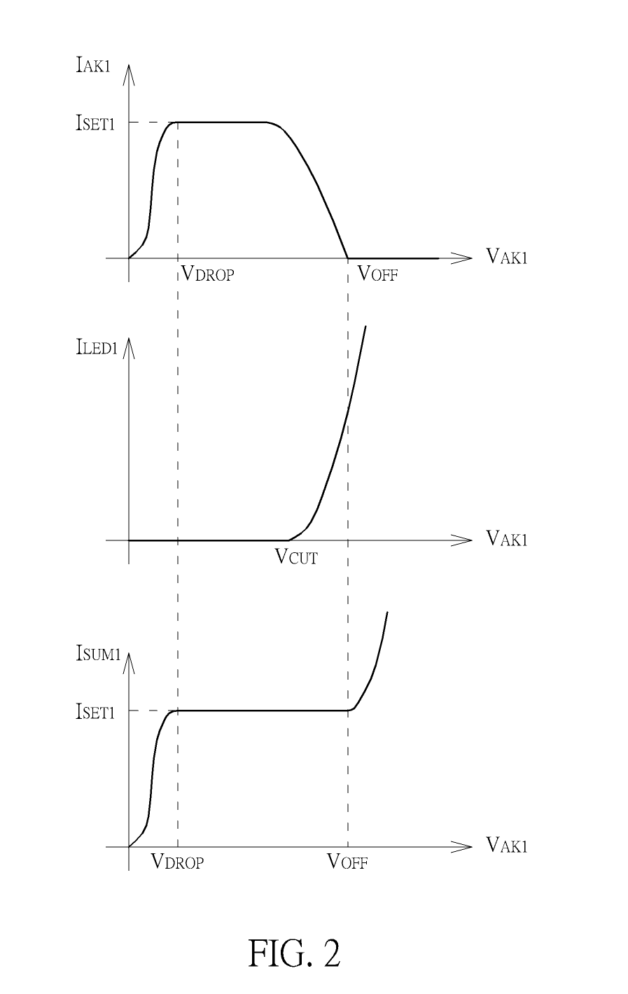

FIG. 2 is a diagram illustrating the operation of the current controller in the driving stages ST₁˜ST_{N}. The 1^{st} driving stage ST₁ is used for illustrative purpose. When 0<V_{AK1}<V_{DROP}, the current controller CC₁ is not completely turned on, and the luminescent device A₁ remains off. Under such circumstance, the current controller CC₁ operates as a voltage-controlled device in a linear mode in which the current I_{AK1} and the total current I_{SUM1} change with the voltage V_{AK1} in a specific manner, while the current I_{LED1} remains zero.

When V_{AK1}>V_{DROP}, the current I_{SUM1} reaches the maximum current setting I_{SET1} of the 1^{st} driving stage ST₁, and the current controller CC₁ switches to a constant-current mode and functions as a current limiter. The current detector CS₁ is configured to monitor the value of the current I_{SUM1} whose variation is reflected by the feedback voltage V_{FB1}. For example, when V_{DROP}<V_{AK1}<V_{CUT}, the luminescent device A₁ remains off and the current controller CC₁ is configured to clamp the current I_{AK1} flowing through the current source IS₁ to the constant value I_{SET1}. When V_{AK1}>V_{CUT}, the luminescent device A₁ is turned on and the current I_{LED1} starts to increase. Therefore, the current controller CC₁ may decrease the current I_{AK1} flowing through the current source IS₁ according to the feedback voltage V_{FB1}, so that the total current I_{SUM1} flowing through the 1^{st} driving stage may be maintained at the constant value I_{SET1} instead of changing with the voltage V_{AK1}.

When the voltage V_{AK1} reaches a turn-off voltage V_{OFF}, the current I_{AK1} drops to zero and the current controller CC₁ switches to a cut-off mode. In other words, the current controller CC₁ functions as an open-circuited device, allowing the current I_{LED1} and the current I_{SUM1} to increase with the voltage V_{AK1}.

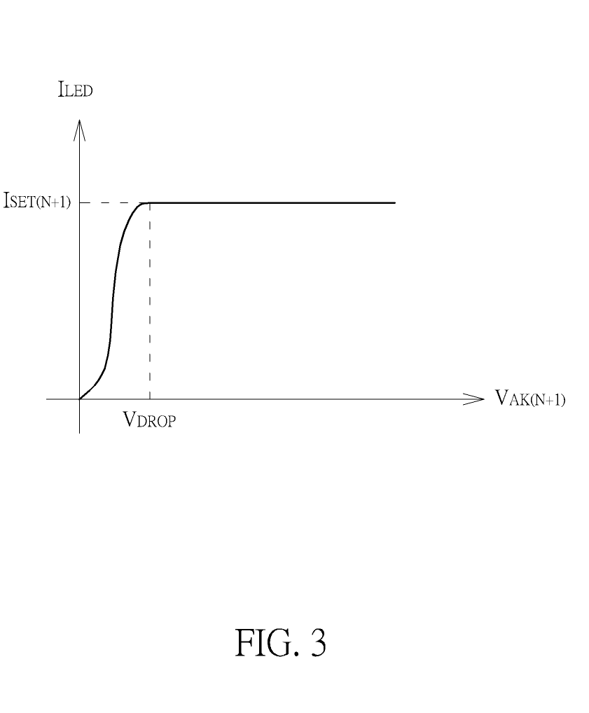

FIG. 3 is a diagram illustrating the operation of the (N+1)^{th} driving stages ST_{N+1}. When 0<V_{AK(N+1)}<V_{DROP}, the current controller CC_{N+1} is not completely turned on. Under such circumstance, the current controller CC_{N+1} operates as a voltage-controlled device in the linear mode in which the current I_{LED} changes with the voltage V_{AK(N+1)} in a specific manner. When V_{AK(N+1)}>V_{DROP}, the current I_{LED} reaches the maximum current setting I_{SET(N+1)} of the (N+1)^{th} driving stages ST_{N+1}, and the current controller CC_{N+1} switches to the constant-current mode and functions as a current limiter. The current detector CS_{N+1} is configured to monitor the value of the current I_{LED} whose variation may be reflected by the feedback voltage V_{FB(N+1)}. Therefore, the current controller CC_{N+1} may switch back to the linear mode once the current I_{LED} drops below I_{SET(N+1)}.

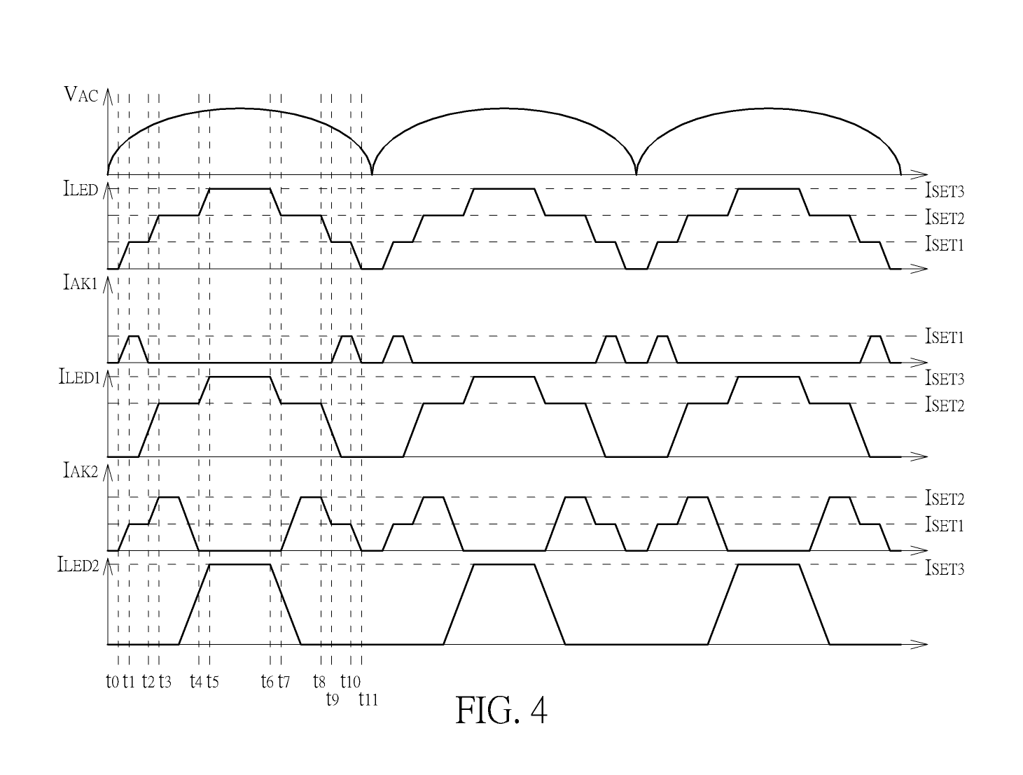

FIG. 4 is a diagram illustrating the operation of the LED lighting device 100. The embodiment when N=2 is used for illustrative purpose. Since the voltages V_{AK1}˜V_{AK3} are associated with the rectified AC voltage V_{AC} whose value varies periodically with time, a cycle of t₀-t₁₁ is used for illustration, wherein the period between t₀-t₅ belongs to the rising period of the rectified AC voltage V_{AC} and the period between t₆-t₁₁ belongs to the falling period of the rectified AC voltage V_{AC}.

Before t₀, the rectified AC voltage V_{AC} is small and the voltages V_{AK1}˜V_{AK3} are insufficient to turn on the luminescent devices A₁˜A₃ or the current controllers CC₁˜CC₃. Therefore, all the current controllers CC₁˜CC₃ in the 3 driving stages ST1˜ST3 operate in the cut-off mode, and the overall current I_{LED} of the LED lighting device 100 is zero.

As previously stated, the turn-on voltages of the current controllers CC₁˜CC₃ are smaller than those of the corresponding luminescent devices A₁˜A₃ in the present invention. At t₀, the rectified AC voltage V_{AC} becomes large enough so that the voltage V_{AK1}˜V_{AK3} are sufficient to turn on the current controllers CC₁˜CC₃ and the luminescent device A3, but still insufficient to turn on the luminescent devices A₁˜A₂, thereby allowing the current I_{LED} to flow through the current controllers CC₁˜CC₃ and the luminescent device A₃. Between t₀˜t₁, all 3 current controllers CC₁˜CC₃ operate in the linear mode in which the overall current I_{LED} of the LED lighting device 100 increases with the rectified AC voltage V_{AC} in a specific manner.

At t₁ as the current I_{LED} reaches I_{SET1}, the current controller CC₁ in the first driving stage ST₁ switches to the constant-current mode, while the current controllers CC₂˜CC₃ in the second and third driving stages ST₂˜ST₃ remain operating in the linear mode. Between t₁˜t₂ after the rectified AC voltage V_{AC} becomes large enough so that the voltage V_{AK1} is sufficient to turn on the luminescent device A₁, the current I_{LED1} starts to increase with the rectified AC voltage V_{AC}. In response to the increase in the current I_{LED1} which is monitored by current detector CS₁, the current controller CC₁ operating in the constant-current mode may decrease the current I_{AK1} accordingly so that the overall current I_{LED} of the LED lighting device 100 is maintained at a constant value (I_{LED}=I_{SET1}) regardless of the level of the rectified AC voltage V_{AC}.

At t₂ as the current I_{AK1} drops to zero, the current controller CC₁ in the first driving stage ST₁ switches to the cut-off mode, while the current controllers CC₂˜CC₃ in the second and third driving stages ST₂˜ST₃ remain operating in the linear mode. Between t₂˜t₃, the current I_{LED} flows through the luminescent devices A₁ and A₃ and the current controllers CC₂˜CC₃, and increases with the rectified AC voltage V_{AC}.

At t₃ as the current I_{LED} reaches I_{SET2}, the current controller CC₂ in the second driving stage ST₂ switches to the constant-current mode, while the current controller CC₁ in the first driving stage ST₁ remains operating in the cut-off mode and the current controller CC₃ in the third driving stage ST₃ remains operating in the linear mode. Between t₃˜t₄ after the rectified AC voltage V_{AC} becomes large enough so that the voltage V_{AK2} is sufficient to turn on the luminescent device A₂, the current I_{LED2} starts to increase with the rectified AC voltage V_{AC}. In response to the increase in the current I_{LED2} which is monitored by current detector CS₂, the current controller CC₂ operating in the constant-current mode may decrease the current I_{AK2} accordingly so that the overall current I_{LED} of the LED lighting device 100 is maintained at a constant value (I_{LED}=I_{SET2}) regardless of the level of the rectified AC voltage V_{AC}.

At t₄ as the current I_{AK2} drops to zero, the current controller CC₂ in the second driving stage ST₂ switches to the cut-off mode, while the current controller CC₁ in the first driving stage ST₁ remains operating in the cut-off mode and the current controller CC₃ in the third driving stage ST₃ remains operating in the linear mode. Between t₄˜t₅, the current I_{LED} flows through the luminescent devices A₁˜A₃ and the current controller CC₃, and increases with the rectified AC voltage V_{AC}.

At t₅ as the current I_{LED} reaches I_{SET3}, the current controller CC₃ in the third driving stage ST₃ switches to the constant-current mode, while the current controllers CC₁˜CC₂ in the first and second driving stages ST₁˜ST₂ remain operating in the cut-off mode. Between t₅˜t₆, the current I_{LED} is maintained at a constant value (I_{LED}=I_{SET3}) regardless of the level of the rectified AC voltage V_{AC}. At t₆ as the current I_{LED} becomes smaller than I_{SET3} the current controller CC₃ switches back to the linear mode, allowing the current I_{LED} to decrease with the rectified AC voltage V_{AC}. The intervals t₀˜t₁, t₁˜t₂, t₂˜t₃, t₃˜t₄ and t₄˜t₅ during the rising period correspond to the intervals t₁₀˜t₁₁, t₉˜t₁₀, t₈˜t₉, t₇˜t₈ and t₆˜t₇ during the falling period, respectively. Therefore, the operation of the LED lighting device 100 during t₆-t₁₁ is similar to that during t₀˜t₅, as detailed in previous paragraphs.

The following table summarizes the operational modes of the current controllers CC₁˜CC₃, wherein mode 1 represents the linear mode, mode 2 represents the constant-current mode, and mode 3 represents the cut-off mode.

TABLE

| | t0~t1 | t1~t2 | t2~t3 | t3~t4 | t4~t5 | |
|---|---|---|---|---|---|---|
| | t10~t11 | t9~t10 | t8~t9 | t7~t8 | t6~t7 | t5~t6 |
| current controller | mode 1 | mode 2 | mode 3 | mode 3 | mode 3 | mode 3 |
| CC₁ | | | | | | |
| current controller | mode 1 | mode 1 | mode 1 | mode 2 | mode 3 | mode 3 |
| CC₂ | | | | | | |
| current controller | mode 1 | mode 1 | mode 1 | mode 1 | mode 1 | mode 2 |
| CC₃ | | | | | | |

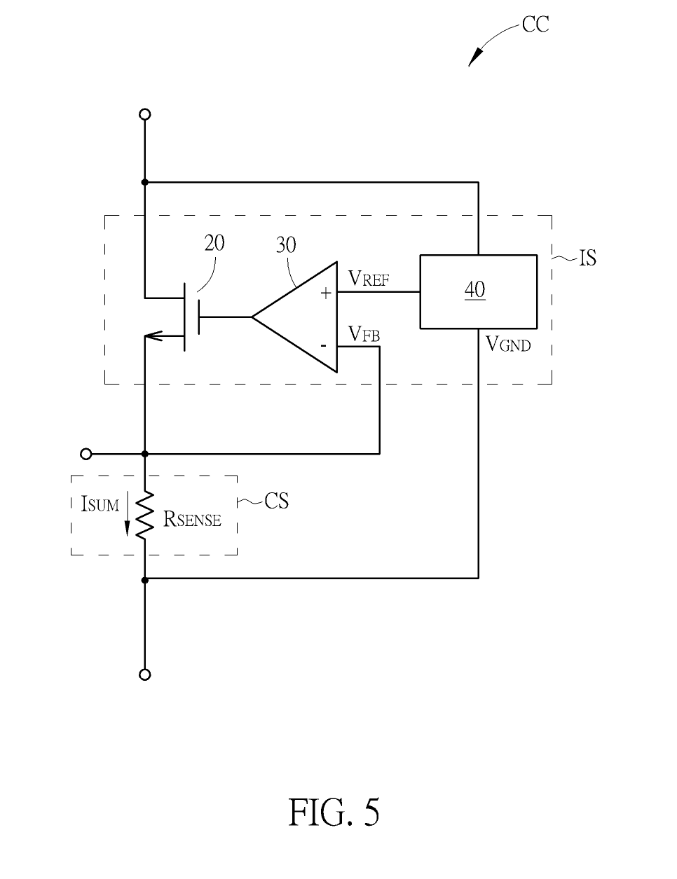

FIG. 5 is a diagram illustrating an embodiment of a current controllers CC according to the present invention. The current controller CC includes an adjustable current source IS and a current sensor CS. The current sensor CS includes a resistor R_{SENSE} arranged to detect a current I_{SUM} by providing a feedback voltage V_{FB}. The adjustable current source IS includes a transistor 20, an operational amplifier 30 and a voltage generator 40. The transistor 20 may include a field effect transistor (FET), a bipolar junction transistor (BJT) or other devices having similar function. In FIG. 5, an N-channel metal-oxide-semiconductor field effect transistor (N-MOSFET) is used for illustration, but does not limit the scope of the present invention. The voltage generator 40 is configured to provide a reference voltage V_{REF} The operational amplifier 30 includes a positive input end coupled to the reference voltage V_{REF}, a negative input end coupled to the feedback voltage V_{FB}, and an output end coupled to the control end of the transistor 20. V_{GND} represents a reference node in the current controllers CC.

The current setting I_{SET} of the current controller CC is equal to (V_{REF}/R_{SENSE}). When I_{SUM}<I_{SET}, the operational amplifier 30 is configured to raise its output voltage for increasing the current flowing through the transistor 20 until the feedback voltage V_{FB} reaches the reference voltage V_{REF}. When I_{SUM}>I_{SET}, the operational amplifier 30 is configured to decrease its output voltage for reducing the current flowing through the transistor 20 until the feedback voltage V_{FB} reaches the reference voltage V_{REF}.

When applying the embodiment of FIG. 5 to the 1^{st} to (N+1)^{th} driving stages ST₁˜ST_{N+1} illustrated in FIG. 1, the current controllers CC₁˜CC_{N+1} may operate according to specific reference voltages V_{REF1}˜V_{REF(N+1)} and the current sensors CS₁˜CS_{N+1} may adopt specific sensing resistors R_{SENSE1}˜R_{SENSE(N+1)} in order to provide different current settings I_{SET1}˜I_{SET(N+1)}. For example, the current setting I_{SET1} of the 1^{st} driving stage ST₁ may be equal to (V_{REF1}/R_{SENSE1}), the current setting I_{SET2} of the 2^{nd} driving stage ST₂ may be equal to (V_{REF2}/R_{SENSE2}), . . . , and the current setting I_{SET(N+1)} of the (N+1)^{th} driving stage ST_{N+1} may be equal to (V_{REF(N+1)}/R_{SENSE(N+1)}). The value of the current setting I_{SET(N+1)} is larger than any of the current settings I_{SET1}˜I_{SETN}.

In an embodiment of the present invention, the sensing resistors R_{SENSE1}˜R_{SENSE(N+1)} may be implemented as a programmable resistor array so that the turn-on/off sequence of the current controllers CC₁˜CC_{N+1} may be flexibly adjusted. In other words, the current setting I_{SET(N+1)} is set to be the largest, and the current settings I_{SET1}˜I_{SETN} may have different relationships depending on the desired turn-on/off sequences. In the embodiment when N=2 as depicted in FIG. 4, the sensing resistors R_{SENSE1}˜R_{SENSE3} are chosen so that I_{SET1}<I_{SET2}<I_{SET3} However, the relationship of the current settings I_{SET1}˜I_{SETN} do not limit the scope of the present invention.

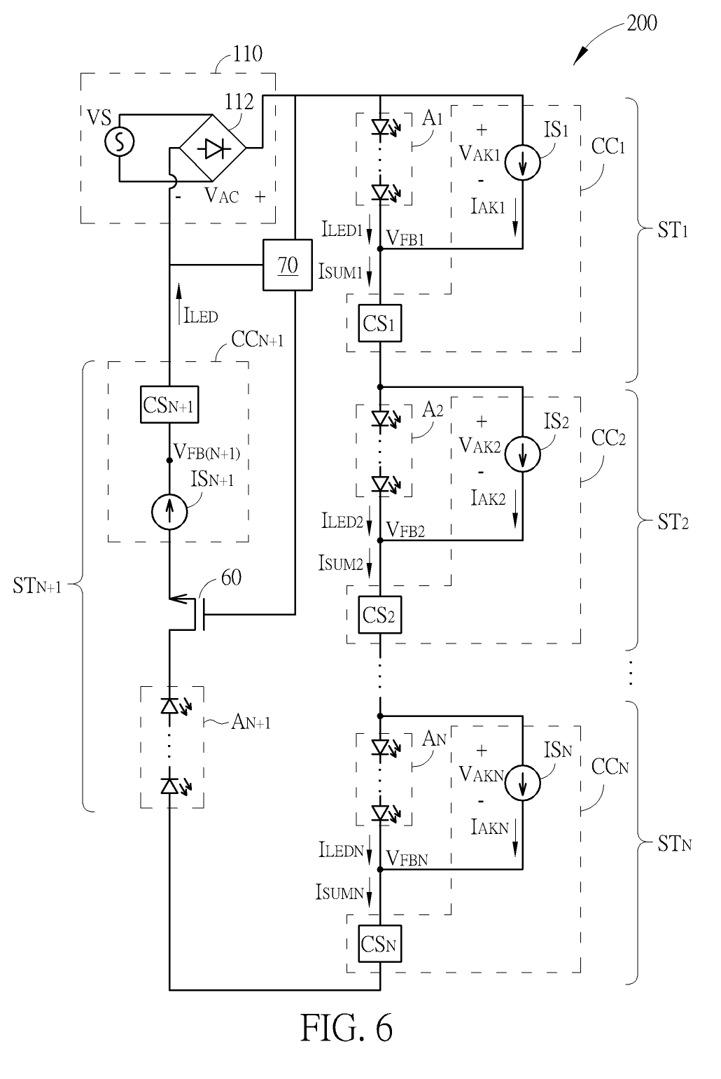

FIG. 6 is a diagram of an LED lighting device 200 according to another embodiment of the present invention. The LED lighting device 200 includes a power supply circuit 110 and (N+1) driving stages ST₁˜ST_{N+1} (N is a positive integer larger than 1). The configurations and operations of the 1^{st} to N^{th} driving stages ST₁˜ST_{N} in the LED lighting device 200 are identical to those of the LED lighting device 100, as illustrated in previous paragraphs. The configuration and operation of the (N+1)^{th} driving stage ST_{N+1} in the LED lighting device 200 are similar to those of the LED lighting device 100, but the (N+1)^{th} driving stage ST_{N+1} in the LED lighting device 200 further includes a high-voltage transistor 60 and a voltage clamping circuit 70. The transistor 60 may include an FET, a BJT or other devices having similar function. In FIG. 6, an N-MOSFET is used for illustration, but does not limit the scope of the present invention. In a scenario when the AC voltage VS somehow fluctuates and the rectified AC voltage V_{AC} is raised above its upper design limit, the voltage clamping circuit 70 is configured to clamp the voltage established across the current controllers CC_{N+1} at a upper limit and allow the redundant voltage due to the fluctuations of the rectified AC voltage V_{AC} to drop on the high-voltage transistor 60, thereby providing overvoltage protection to the luminescent devices A₁˜A_{N+1} and the current controllers CC₁˜CC_{N+1}. In another scenario when the redundant voltage due to the fluctuations of the rectified AC voltage V_{AC} exceeds the upper drain-to-source voltage limit of the high-voltage transistor 60, the voltage clamping circuit 70 may provide overvoltage protection to the luminescent devices A₁˜A_{N+1} and the current controllers CC₁˜CC_{N+1} by turning off the transistor 60.

With the above-mentioned multi-stage driving scheme, the present invention may turn on multiple luminescent devices flexibly using multiple current controllers. The LED lighting device of the present invention may adopt different amount and various types of luminescent devices since the overall LED current is regulated according to the current of each driving stage instead of the cut-in voltage of the LEDs.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light-emitting diode (LED) lighting device having multiple driving stages, comprising:
a first driving stage including:
a first luminescent device for providing light according to a first current; and
a first current controller coupled in parallel with the first luminescent device and configured to conduct a second current according to a voltage established across the first current controller and regulate the second current so that a sum of the first current and the second current does not exceed a first value; and
a second driving stage including:
a second luminescent device coupled in series to the first luminescent device for providing light according to a third current; and
a second current controller coupled in series to the second luminescent device and configured to regulate the third current so that the third current does not exceed a second current setting which is larger than the first value, wherein each of the first and second luminescent devices includes one LED or multiple LEDs.

2. The LED lighting device of claim 1, wherein:
during a rising period of a rectified alternative-current (AC) voltage when the voltage established across the first current controller does not exceed a first voltage, the first current controller operates in a first mode in which the second current increases with the rectified AC voltage;
during the rising period when the voltage established across the first current controller exceeds the first voltage and the second current is larger than zero, the first current controller operates in a second mode in which the sum of the first current and the second current is maintained at the first value; and
during the rising period when the voltage established across the first current controller exceeds the first voltage and the second current is equal to zero, the first current controller operates in a third mode in which the first current controller is turned off.

3. The LED lighting device of claim 2, wherein:
during the rising period when the voltage established across the first current controller exceeds the first voltage but is smaller than a turn-on voltage of the first luminescent device, the first current controller is configured to operates in the second mode by clamping the second current at the first value; and
during the rising period when the voltage established across the first current controller exceeds the turn-on voltage of the first luminescent device, the first current controller is configured to operates in the second mode by reducing the second current as the first current increases so that the sum of the first current and the second current is maintained at the first value.

4. The LED lighting device of claim 2, wherein:
during a falling period of the rectified AC voltage when the voltage established across the first current controller does not exceed the first voltage, the first current controller operates in the first mode in which the second current decreases with the rectified AC voltage;
during the falling period when the voltage established across the first current controller exceeds the first voltage and the second current is larger than zero, the first current controller operates in the second mode in which the sum of the first current and the second current is maintained at the first value; and
during the falling period when the voltage established across the first current controller exceeds the first voltage and the second current is equal to zero, the first current controller operates in the third mode in which the first current controller is turned off.

5. The LED lighting device of claim 4, wherein:
during the falling period when the voltage established across the first current controller exceeds the first voltage but is smaller than the turn-on voltage of the first luminescent device, the first current controller is configured to operates in the second mode by clamping the second current at the first value; and
during the falling period when the voltage established across the first current controller exceeds the turn-on voltage of the first luminescent device, the first current controller is configured to operates in the second mode by increasing the second current as the first current decreases so that the sum of the first current and the second current is maintained at the first value.

6. The LED lighting device of claim 2, wherein the first current controller includes:
a first current sensor configured to provide a first feedback voltage which is associated with the sum of the first current and the second current;
a first adjustable current source configured to:
conduct the second current according to the rectified AC voltage when the first current controller operates in the first mode;
regulate the second current according to the first feedback voltage when the first current controller operates in the second mode; and
switch off when the first current controller operates in the third mode.

7. The LED lighting device of claim 6, wherein:
the first adjustable current source includes:
a voltage generator configured to provide a reference voltage;
an operational amplifier configured to provide a control voltage according to a difference between the reference voltage and the first feedback voltage, the operational amplifier including:
a first input end coupled to the reference voltage;
a second input end coupled to the first feedback voltage; and
an output end for outputting the control voltage;
a transistor configured to conduct the second current according to the control voltage, the transistor including:
a first end coupled to a first end of the first luminescent device;
a second end coupled to a second end of the first luminescent device; and
a control end coupled to the output end of the operational amplifier; and
the first current sensor includes a resistor having a first end coupled to the second end of the transistor and a second end coupled to a reference node.

8. The LED lighting device of claim 1, wherein:
during a rising period of a AC voltage when the voltage established across the second current controller does not exceed a second voltage, the second current controller operates in a first mode in which the third current increases with the rectified AC voltage; and
during the rising period when the voltage established across the second current controller exceeds the second voltage, the second current controller operates in a second mode in which the third current is maintained at a second value.

9. The LED lighting device of claim 8, wherein:
during a falling period of the rectified AC voltage when the voltage established across the second current controller does not exceed the second voltage, the second current controller operates in the first mode in which the third current decreases with the rectified AC voltage; and
during the falling period when the voltage established across the second current controller exceeds the second voltage, the second current controller operates in the second mode in which the third current is maintained at the second value.

10. The LED lighting device of claim 8, wherein the second current controller includes:
a second current sensor coupled in series to the second luminescent device and configured to provide a second feedback voltage which is associated with the third current; and
a second adjustable current source configured to:
conduct the third current according to the rectified AC voltage when the second current controller operates in the first mode; and
regulate the third current according to the second feedback voltage when the second current controller operates in the second mode.

11. The LED lighting device of claim 10, wherein:
the second adjustable current source includes:
a voltage generator configured to provide a reference voltage;
an operational amplifier configured to provide a control voltage according to a difference between the reference voltage and the second feedback voltage, the operational amplifier including:
a first input end coupled to the reference voltage;
a second input end coupled to the second feedback voltage; and
an output end for outputting the control voltage;
a transistor configured to conduct the third current according to the control voltage, the transistor including:
a first end coupled to an end of the second luminescent device;
a second end; and
a control end coupled to the output end of the operational amplifier; and
the second current sensor includes a resistor having a first end coupled to the second end of the transistor and a second end coupled to a reference node.

12. The LED lighting device of claim 1, further comprising a third driving stage which includes:
a third luminescent device coupled in series to the first luminescent device and the second luminescent device for providing light according to a fourth current; and
a third current controller coupled in parallel with the third luminescent device and configured to conduct a fifth current according to a voltage established across the third current controller and regulate the fifth current so that a sum of the fourth current and the fifth current does not exceed a third value.

13. The LED lighting device of claim 1 further comprising a power supply circuit configured to provide a rectified AC voltage for driving the first luminescent device and the second luminescent device.

14. The LED lighting device of claim 13 wherein the power supply circuit includes an AC-AC voltage converter.

15. The LED lighting device of claim 1 wherein the second driving stage further comprises:
a transistor including:
a first end coupled to the second luminescent device;
a second end coupled to the second current controller; and
a control end; and
a voltage clamping circuit coupled to the control end of the transistor and configured to control the transistor according to a rectified AC voltage for driving the first luminescent device and the second luminescent device.
